(19) United States
(12) Patent Application Publication
(10) Pub. No.: US 2022/0410646 A1
(43) Pub. Date: Dec. 29, 2022

(54) AUTOMOTIVE DOUBLE DAMPER SUSPENSION SYSTEM

(71) Applicant: VIRGINIA TECH INTELLECTUAL PROPERTIES, INC., Blacksburg, VA (US)

(72) Inventors: Saied Taheri, Blacksburg, VA (US); Anish Gorantiwar, Blacksburg, VA (US); Rajvardhan Nalawade, Columbus, IN (US); Arash Nouri, Blacksburg, VA (US)

(21) Appl. No.: 17/809,081

(22) Filed: Jun. 27, 2022

Related U.S. Application Data
(60) Provisional application No. 63/215,098, filed on Jun. 25, 2021.

(51) Int. Cl. B60G 13/10; B60G 17/015; B60G 17/08

(52) U.S. Cl. CPC B60G 13/10; B60G 17/0155; B60G 17/08; B60G 2202/242

(57) ABSTRACT

In one or more embodiments, a double damper is disclosed that may be used in an automotive suspension system. In one embodiment, a double damper includes a first damper having a first piston rod, a first gas chamber, a first compression chamber, and a first rebound chamber. The double damper further includes a second damper having a second piston rod, a second gas chamber, a second compression chamber, and a second rebound chamber. The first damper and the second damper are connected via a sleeve from which the first piston rod and the second piston rod extend at opposite ends.

### CROSS-REFERENCE TO RELATED APPLICATION

This application claims the benefit of and priority to U.S. Provisional Patent Application No. 63/215,098 filed Jun. 25, 2021, entitled “AUTOMOTIVE DOUBLE DAMPER SUSPENSION SYSTEM,” the contents of which being incorporated by reference in their entirety herein.

### BACKGROUND

The automotive suspension system plays a crucial role in maintaining the vehicle dynamics of the car for changes in road input and variations in the normal weight distribution. An effective suspension system ensures passenger ride comfort for unpredictable input variations and allows a sufficient amount of tire-road contact for proper road handling. There are three commonly used suspension systems—passive, semi-active, and active suspensions with each one having its advantages and limitations over the other. Conventional passive suspension systems come with the inherent limitation that they cannot cater to both road-holding and ride comfort at the same time. For example, a soft suspension system may be better at providing ride comfort but will not perform as well in handling as compared to a harder, stiffer suspension and vice-versa. Active suspensions, on the other hand, have inherent drawbacks of having a complex structure and high cost.

### BRIEF SUMMARY

Various embodiments are disclosed for an automotive double damper suspension system. A first embodiment includes a double damper. The double damper also includes a first semi-active damper including a first piston rod, a first gas chamber, a first compression chamber, a first rebound chamber, and a first bypass chamber, the first bypass chamber including a first controllable bypass valve. The damper also includes a second semi-active damper including a second piston rod, a second gas chamber, a second compression chamber, a second rebound chamber, and a second bypass chamber including a second controllable bypass valve. The two semi-active dampers are essentially connected to each other via a sleeve arrangement.

A second embodiment includes a system. The system also includes a double damper may include a first semi-active damper and a second semi-active damper in series via a sleeve arrangement. The system also includes the first semi-active damper having a first controllable bypass valve that controls a flow of hydraulic oil from a first compression chamber to a first rebound chamber. The system also includes the second semi-active damper having a second controllable bypass valve that controls a flow of hydraulic oil from a second compression chamber to a second rebound chamber. The system also includes a controller that operates the first controllable bypass valve according to a skyhook control algorithm and operates the second controllable bypass valve according to a Groundhook control algorithm.

A third embodiment includes a double damper. The double damper also includes a first damper including a first piston rod, a first gas chamber, a first compression chamber, and a first rebound chamber. The double damper also includes a second damper including a second piston rod, a second gas chamber, a second compression chamber, and a second rebound chamber. The two dampers are essentially connected to each other via a sleeve arrangement.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a longitudinal section view of a double damper according to one or more embodiments.

FIG. 2 is a drawing of an example test apparatus for evaluating the performance of the double damper of FIG. 1 according to one or more embodiments.

FIG. 3 is a block diagram of the experimental setup used for data collection and testing of the double damper of FIG. 1 on the shock dyno of FIG. 2 according to one or more embodiments.

FIG. 4A shows one example of a force versus absolute velocity plot for a single damper measured with the test apparatus of FIG. 2 according to one or more embodiments.

FIG. 4B shows one example of a force versus absolute velocity plot for the double damper of FIG. 1 measured with the test apparatus of FIG. 2 according to one or more embodiments.

FIG. 5A shows the force versus displacement plot of the double damper of FIG. 1 when it is subjected to no control algorithm according to one or more embodiments.

FIG. 5B shows the force versus velocity plot of the double damper of FIG. 1 when the solenoid valve is fully open according to one or more embodiments.

FIG. 6 is a diagram illustrating a data processing workflow for comparison of semi-active single damper and double damper performance according to one or more embodiments.

FIG. 7 shows one example of a frequency domain sprung mass acceleration plot for both a semi-active single damper and the double damper of FIG. 1 according to one or more embodiments.

### DETAILED DESCRIPTION

The present disclosure relates to an automotive double damper suspension system, which may include semi-active control. Obtaining the best performance from any suspension for a spectrum of different operating conditions such as road undulations, vehicle speed variations, and fixed working space, requires the adjustment of suspension parameters through wide ranges.

Active suspension systems change the damping coefficient of the vehicle suspension by applying a force with the help of hydraulic or electric actuators. These controlled forces help in modifying the ride and handling characteristics at every instant in real-time. Even though hydraulic active suspension systems have slightly better ride comfort and handling characteristics, hydraulic active suspension systems come with inherent drawbacks of having a complex structure and a very high cost. Along with this, the use of different control algorithms for semi-active dampers has increased their reliability over the active suspension systems. These advantages of semi-active dampers justify their use for commercial vehicle applications.

Semi-active suspension systems lie between passive and active in terms of performance, cost, and complexity. They can vary the damping characteristics by either using a variable orifice or variable viscosity fluids. Variable orifice semi-active suspension systems use a position control valve to adjust the orifice area through which the damper fluid flows. This variation in orifice area is directly proportional to the damping coefficient, which in turn varies the force transmitted to the vehicle chassis. Variable fluid viscosity semi-active dampers, by contrast, make use of Electrorheological (ER) and Magnetorheological (MR) fluids to vary the damping force. When subjected to a magnetic field, the MR fluids change their properties and act as a semi-solid material, thus altering the damping properties of the damper.

A Magne-Ride Delphi damper is an MR damper for testing three specific control algorithms: on-off Skyhook control, continuous Skyhook control and a Skyhook algorithm based fuzzy logic control. However, these MR dampers have inherent limitations of particle settling within the damper, causing abrasions. These abrasions along the inner wall of the damper may lead to wearing damper material resulting in decreased life.

In one example, MR dampers were used for semi-active suspension control using Skyhook Control. A B class vehicle was used, and the conventional four hydraulic dampers were replaced with MR dampers. Eight accelerometers were used, four for sprung and four for unsprung mass accelerations. This example reduced the peak vertical acceleration of the driver's seat to 0.32 g.

In another example, a state-observer based fuzzy controller was used for a MR damper. The validation of the algorithm was done on a quarter car test rig that had provisions for collecting the sprung and unsprung mass acceleration data.

In another example, a Linear Variable Differential Transformer (LVDT) was used, along with accelerometers, for measuring the vertical deflection of the suspension on an instrumented All-Terrain Vehicle. A sampling frequency of 500 Hz and a frequency of excitation between 1.5 and 12 Hz were used. An accelerometer-based velocity estimation was determined to give better results for Skyhook control, whereas the Groundhook control performed better with LVDT-based measurement methods.

In another example, a variable damping control strategy was implemented on a variable orifice damper. Displacement sensors were employed as a feedback unit upon which the variable damping control strategy was based. A reduction in the body, roll, and pitch angle accelerations were found in comparison with a passive damper.

Various embodiments of the present disclosure introduce a double damper suspension system. In some embodiments, a Hybrid Skyhook-Groundhook control algorithm is employed in the double damper suspension system.

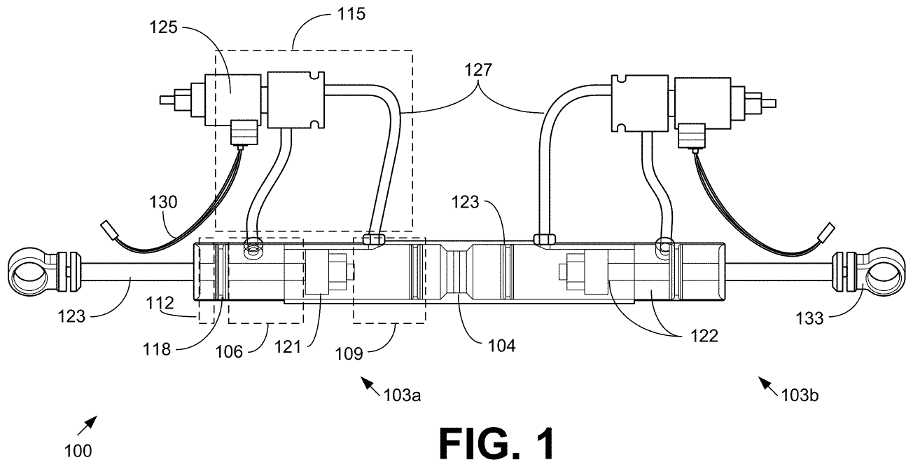

FIG. 1 is a drawing of a longitudinal section view of a double damper 100 according to one or more embodiments. A double damper 100 includes two controllable dampers 103a, 103b placed in series within and separated by a sleeve 104 (e.g., an aluminum sleeve). In various examples, one or more of the dampers 103 in the double damper 100 are passive dampers, semi-active dampers, or active dampers. In one example, the double damper 100 is installed such that the damper 103a is positioned vertically above the damper 103b. Each of the dampers 103 of the double damper 100 includes four main chambers—a compression chamber 106, a rebound chamber 109, a gas chamber 112, and a bypass chamber 115, respectively. The gas chamber 112 is at the top of the tube, being separated from the compression chamber 106 by a floating piston 118 or bushing. The floating piston 118 separates the nitrogen in the gas chamber 112 from the hydraulic oil in the compression chamber 106.

The compression chamber 106 sits between the floating piston 118 of the gas chamber 112 and the internal piston 121. A shim stack 122 as shown is provided in the compression chamber 106. On the other side of the internal piston 121 and opposite to the compression chamber 106 is the rebound chamber 109. The rebound chamber 109 is connected to the internal piston 121 of the damper 103 by a piston rod 123. The piston rods 123 extend out of the double damper body at opposite ends. A gas piston 123 may be provided in the rebound chamber 109. Also, the rebound chamber 109 is connected to the compression chamber 106 through a bypass valve 125.

The bypass valves 125 may comprise solenoid valves, one for each damper 103. The bypass valves 125 control the flow rate of oil passing in the hoses 127 from the compression chamber 106 to the rebound chamber 109 for each individual damper 103. In one embodiment, the hoses 127 exit the body of the double damper 100 and the bypass valves 125 are located external to the body of the double damper 100. The double damper 100 was modeled, taking into account pressure and flow variations within the double damper 100. The controllable bypass valves 125 may be attached to a controller by way of wires 130.

The eyelet ends 133 of each damper 103 may be joined, in an automotive suspension system, respectively to a wheel hub attachment point and a vehicle chassis point. The eyelet ends 133 are attached to the outside ends of the piston rods 123.

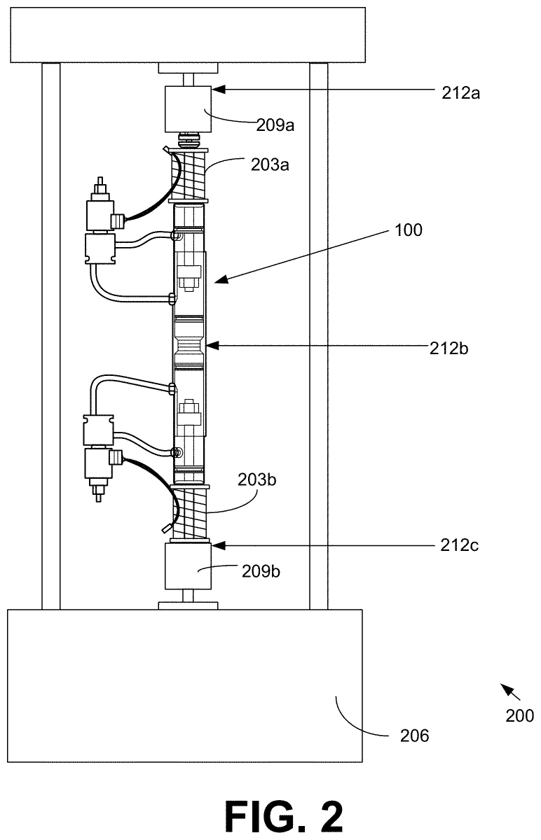

FIG. 2 is a drawing of an example test apparatus 200 for evaluating the performance of the double damper 100. For experimentation, a set of two springs 203a, 203b may be attached in parallel to the double damper 100. These springs 203 correspond to the typical configuration of mounting a shock absorber in a vehicle. For testing a single damper, due to geometrical constraints, a single spring may be attached in parallel to this damper. The spring attached in parallel with the single damper has a stiffness coefficient equivalent to the combined stiffness of the two springs in parallel with the double damper. The double damper 100 is mounted within a shock dyno 206 using the respective mounts 209a and 209b. In the mounts 209, a bolt may pass through the eyelet ends 133 (FIG. 1) of the double damper 100 in order to connect the mounts 209 to the double damper 100.

The test apparatus 200 may include, for example, three accelerometers 212a, 212b, 212c that are used in controlling the double damper 100. An upper accelerometer 212a measures the acceleration corresponding to the vehicle sprung mass. A body accelerometer 212b measures the acceleration of the body portion of the double damper 100. A lower accelerometer 212c measures the acceleration corresponding to the vehicle unsprung mass.

A control algorithm for controlling the damping coefficient of the double damper is implemented based on the relative velocity difference between the sprung and unsprung mass in real-time. A dedicated experimental setup has been developed for evaluating the performance of the semi-active double damper for different operating conditions. The control algorithm and its implementation for the double-damper are explained in the subsequent sections. Later results were compared to a semi-active single damper as a benchmark to evaluate the performance of the double-damper.

In order to evaluate the performance of dampers, a metric called “comfort cost” is compared. Comfort cost can be considered as the extent of comfort a particular ride can offer on undulated topography. Comfort cost is implemented by calculating the spectral power of the sprung mass acceleration data in the low frequency range. The power of a signal in low frequency zone corresponds to the extent of comfort a damper can provide. Since the human comfort is associated with lower frequencies, this range is looked for evaluating comfort cost. Similarly, the spectral energy content of data at high frequencies is seen for evaluating the road holding property of the vehicle as the tire hop frequency is comparatively higher. A low spectral energy content in the low frequency zone corresponds to a smoother ride as the sprung mass resonances are more damped. Since the resonances are damper, it essentially leads to a less area under the curve in the spectral domain, and hence smaller power spectral density. With respect to these properties, comfort cost is chosen for evaluating the ride comfort offered by different dampers.

Different control strategies may be implemented to minimize the vertical acceleration of the sprung mass and to improve the road-holding capabilities by varying the orifice area of the solenoid valves. In one embodiment, a double damper system uses a hybrid control algorithm that employs Groundhook control on the lower damper and Skyhook control on the upper damper. In another embodiment, the double damper system employs Groundhook control on both dampers. In another embodiment, the double damper system employs Skyhook control on both dampers.

Skyhook control operates assuming that a damper is connected to the sky (a fixed y-axis coordinate). If the damper is expanding and the sprung body is moving towards the damper, then the Skyhook control turns the damper on, and the damper pulls down on the sprung body. The switching law turns the damper off when the direction of the damper velocity is not consistent with the direction of the desired damper force. If it is desired to have the damper pull down on the sprung body but that damper is being compressed, then only an upwards force is available from that damper. The control law will turn the damper off in an effort to minimize the upwards push from the damper.

Groundhook control differs from Skyhook control in that the damper is connected to the unsprung-mass rather than the sprung-mass. In Groundhook control, the focus shifts from the sprung-mass to the unsprung-mass.

In the case of the double damper, the Groundhook control algorithm is implemented on the lower damper to ensure better road handling characteristics and Skyhook control algorithm on the upper damper. This strategy provides improved ride comfort. The use of a hybrid control algorithm reduces the peak-to-peak displacements and accelerations of both sprung and unsprung masses. The control strategy is based upon the relative velocity difference obtained from three accelerometers mounted on the damper and shock dyno mounts. Skyhook control is based on the velocity difference between the double damper (provided by the body accelerometer 212b (FIG. 2)) and the sprung mass (provided by the upper accelerometer 212a), while the Groundhook control is based on the velocity difference between the unsprung mass (provided by the lower accelerometer 212c) and the double damper (provided by the body accelerometer 212b) as shown in equation (1):

xᵤₚₚₑᵣ(xᵤₚₚₑᵣ−x_{body})≥0c_{sky}=cₘₐₓ

xᵤₚₚₑᵣ(xᵤₚₚₑᵣ−x_{body})<0c_{sky}=cₘᵢₙ

−x_{lower}(x_{body}−x_{lower})≥0c_{ground}=cₘₐₓ

x_{lower}(x_{body}−x_{lower})<0c_{ground}=cₘᵢₙ

Where xᵤₚₚₑᵣ is the sprung mass velocity, x_{body} is the double damper velocity, x_{lower} is the unsprung mass velocity, c_{sky} is the upper damping coefficient, and c_{ground} is the lower damping coefficient.

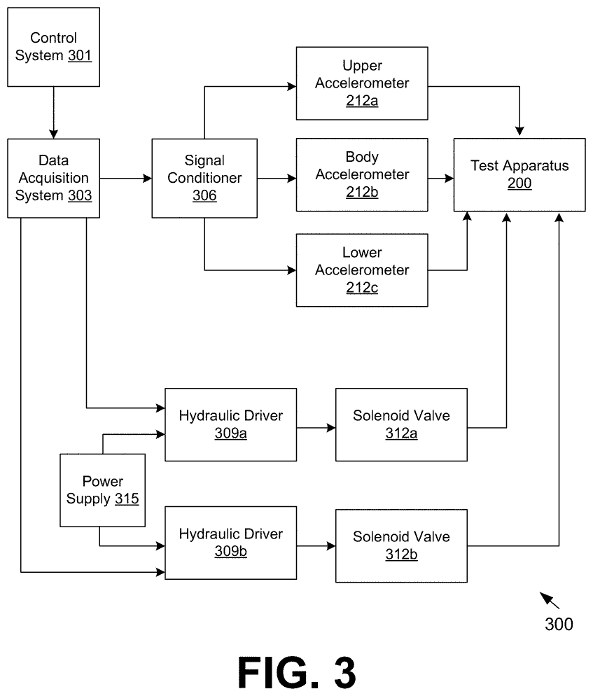

FIG. 3 is a block diagram 300 of the experimental setup used for data collection and testing of the double damper 100 on the shock dyno 206. In various examples, damper testing is carried out on the shock dyno 206 covering frequencies from 0.25 Hz-3 Hz that helps capture damper effects on yaw, roll, and pitch dynamics of a typical vehicle.

The experimental setup for testing the performance of the double damper system comprises a control system 301, a data acquisition system 303 (DAQ) (e.g., NI DAQ USB 6225), a signal conditioner 306 (e.g., DYTRAN 4122b), a test apparatus 200 incorporating the double damper 100 (FIG. 1) and the shock dyno 206 (FIG. 2)(e.g., INTERCOMP Variable Speed Shock Dyno), two hydraulic drivers 309a, 309b (e.g., HYDRAFORCE EVDR-0101A), two solenoid valves 312a, 312b (e.g., HYDRAFORCE SP10-24), three single axis accelerometers 212a, 212b, 212c(e.g., DYTRAN 3225F1), and direct current (DC) power supplies 315.

A variable speed shock dyno 206 is used for providing the input excitation to the damper system. The parameters of the shock dyno 206 include adjustable stroke (values e.g., 0.0254 m, 0.0381 m, 0.0508 m, 0.05715 m), a load cell (value e.g., 907 kg), and a variable speed (values e.g., 0.0127-0.4826 m/s). A load cell may be mounted on top of the upper eyelet of the damper. This arrangement ensures the measurement of the damper force transmitted to the vehicle chassis. The construction of the shock dyno 206 is such that it has a provision of tightening or loosening the top eyelet end 133 (FIG. 1) (sprung mass) of the double damper 100. This provision of loosening the top end is further used for adding different weights on top of the shock dyno 206 mimicking the sprung mass. In order to reduce the vibrations at the upper and the lower ends of the shock dyno 206, mounts 209 (FIG. 2) have been specifically designed corresponding to the eyelet dimensions of the dampers 100.

Three single-axis accelerometers 212 may be used for obtaining the accelerations at three different points of the double damper 100. Three mounting points are chosen on the double damper 100 and the shock dyno 206, which correspond to the unsprung, sprung, and the body accelerations. These are further used as inputs to the control algorithms. The accelerometers 212 may be selected for their low sensitivity and wide frequency response. Petro wax may be used as an adhesive for securing the accelerometers at their respective positions. Example specifications for a single-axis accelerometer 212 may include a sensitivity of 10 mV/g, a frequency response of 1.6-10,000 Hz, a thermal coefficient of sensitivity of 0.054/° C., a supply current of 2-20 mA, and a compliance voltage of +18 to +30V.

Two bypass valves 125 (FIG. 1), which comprise a respective hydraulic driver 309 and a respective solenoid valve 312, are mounted on the double damper 100 to control the amount of fluid flow through the double damper 100. The involvement of fast-acting dynamics weighs in favor of using bypass valves 125 capable of handling high pressure and flow rates during damper testing. In order to take this into account, a bypass valve 125 is used for controlling the flow rate of oil from the compression end to the rebounding end in the experiment. In one example, the bypass valve 125 is a proportional solenoid-operated, 2-way, spool-type, normally closed, providing bi-directional fluid metering, valve. The response time for the bypass valve 125 from fully closed to open fully may be approximately 40 ms. In one example, the sample rate chosen for sending the signal to the solenoid valve 312 from the data acquisition system 303 is 240 Hz. The gas chamber 112 of the double damper 100 may be pressurized to an initial value of 1.37 Mpa. The nitrogen gas in the chamber 112 attains the maximum pressure of 3.79 MPa when the damper 100 is subjected to an example velocity of 0.3048 m/s. The orifice area of the valve can be varied from 0-0.2 in² (0-0.005 m²) thus allowing flow rate of the fluid flow to go up to 0.5 liter/sec (0.0005 m³). The input to this solenoid valve 312 is given by the digital output port of the data acquisition system 303 via the valve driver.

To accurately meter the opening and closing of the solenoid valve, a hydraulic driver 309 is used. This hydraulic driver 309 is a microprocessor-based valve driver mainly used in hydraulic proportional valve applications. It takes inputs from the data acquisition system, which drives the output current to the pre-defined ramp rate, enabling accurate and proportional metering control of the solenoid valve 312. Software such as, for example, HF-Impulse, that is executing on the control system 301 may be used for calibrating the hydraulic driver 309 corresponding to the input signal ratings. The software may enable communication with the driver and the solenoid valve. The software can be used to visualize the input as well as the control output signal, which is provided to the solenoid valve 312. In one example, the driver specifications include power requirements between 9 and 32 VDC, control inputs at frequencies between 50 and 10000 Hz, control output current between 50 and 2000 mA, and a control output pulse width modulation (PWM) between 40 and 400 Hz. The hydraulic driver 309 may be calibrated to take inputs between 0 and 5 V and provide a current signal for the solenoid valve 312 to go from a fully closed (e.g., 0 A) to a fully open (e.g., 1.2 A) state based at least in part on valve specifications.

A data acquisition system 303 is used for is used for collecting the accelerometer data. The analog outputs from the three accelerometers 212 are fed to the analog input ports of the data acquisition system 303. A differential connection is used at the input port of the data acquisition system 303 for connecting the three accelerometers 212. This sensor output data is then acquired. In one non-limiting example, the data acquisition system 303 may have a number of analog input channels, 16-bit resolution, a sample rate of 250 kS/s, and two counters with 32-bit resolution. In one example, the sampling frequency is chosen as 240 Hz, which is the real-time limit of the highest sampling rate that could be achieved with the solenoid valve 312. Also, the asynchronous data collection method may be used, which ensures that the data acquisition from the device and the simulation happen in parallel, enabling quicker simulation time than the synchronous mode. Data from the device may be continuously acquired into a First In First Out (FIFO) buffer in parallel as the simulation runs.

In one example, two control systems 301, such as computers, may be used: one for operating the shock dyno and one for implementing the control algorithms and sending the control signals to the data acquisition system 303. This ensures faster processing for simultaneously running both the shock dyno 206 and the control algorithms. The testing and data collection process for the double damper 100 is carried out at different operating conditions to evaluate their effect on the damper performance. These parameters, which are varied during the testing, are explained in the following.

The double damper 100 is tested under two types of loading conditions. In the first scenario, the upper mount 209a, on which the double damper 100 is mounted, is not free to move. This resembles the conventional damper testing on a shock dyno 206. Due to this kind of loading condition, the force characteristics of the double damper 100 can be obtained for varying displacement and velocity. For the second scenario, in order to take into consideration the effect of sprung mass on the damper characteristics, an external load is added on top of the shock dyno 206, and the upper mount 209a is made free to move. This provision also enables the use of control algorithms as the control logic is based at least in part on the velocity difference of the upper and lower mounting points. The upper limit of the normal load is taken to be 150 lbs. (68 kg). This limit is decided based on the gas pressure inside the damper, which is in the order of 1.37 MPa. Exceeding the normal load above 68 kg compresses the damper entirely up to its bottom dead center, and it starts behaving as a rigid body. The lower limit of the normal load is taken as 50 lbs. (23 kg) based on the fact that loads less than this have no effect in compressing the piston and the damper starts behaving as a solid body.

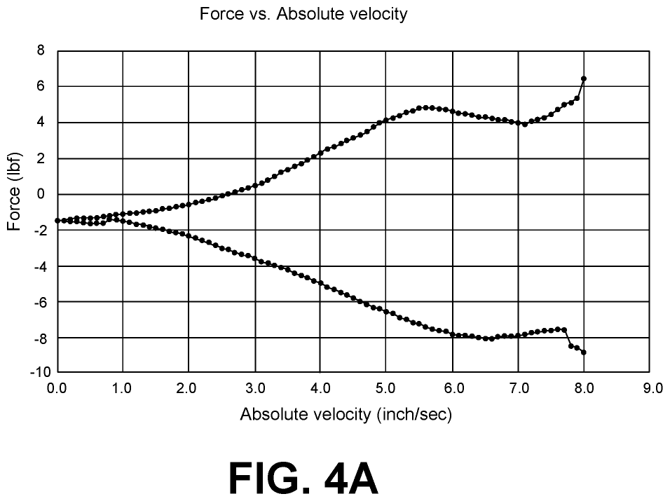

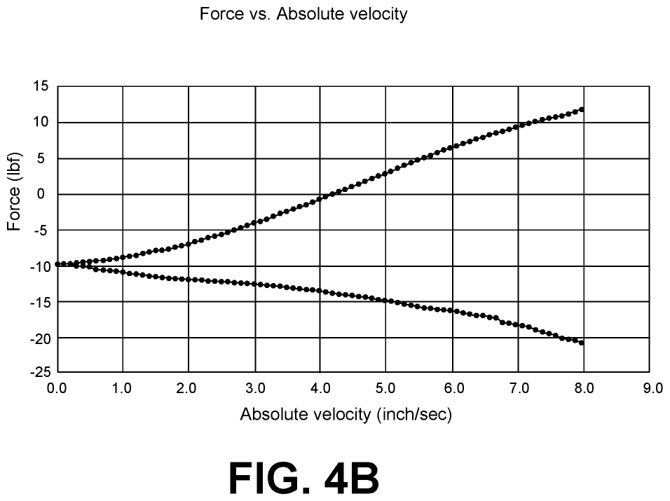

FIG. 4A shows one example of a force versus absolute velocity plot for a single damper measured with the test apparatus 200. FIG. 4B shows one example of a force versus absolute velocity plot for a double damper 100 measured with the test apparatus 200.

In order to cover all the road frequencies, the double damper 100 can be tested with different input velocities. The velocity range may be between 8 and 12 in/sec (0.2-0.3 m/s). The upper limit of the velocity is based on the constraint of the shock dyno; as above this speed, high-frequency vibrations are induced, resulting in corrupted accelerometer data. At lower velocities, after evaluating the accelerometer data, no significant difference could be found between the sprung and the unsprung accelerations. Hence, the lower limit of the velocity was kept at 8 in/sec (0.2 m/s).

The semi-active double damper 100 is tested with a Hybrid Skyhook Groundhook control strategy and the single semi-active damper with Skyhook and Groundhook control to measure their ride comfort characteristics. Each control algorithm has been modelled with identical input parameters. Different operating conditions for damper testing include (1) no load, with 8 in/s (0.20 m/s) input velocity, the Hybrid Groundhook Skyhook algorithm and a single damper; (2) 50 lbs. (22.6 kg) normal load, with 10 in/s (0.25 m/s) input velocity, the Skyhook algorithm, and the double damper; and (3) 100 lbs. (45.35 kg) normal load, with an input velocity of 12 in/s (0.30 m/s), and the Groundhook algorithm.

The passive double damper characteristics are obtained by performing the conventional shock dyno test routine of clamping the upper end of the dyno and evaluating the force variations of the damper to changes in the input displacements and velocities. Each of these graphs is plotted for different velocities ranging from 0.025 to 0.15 m/s (1-6 in/s). The contours at the middle represent the operating condition of the damper at the lowest velocity, e.g., 1 in/s (0.1 m/s). The velocities increase up to 6 in/s (0.15 m/s), in unit increments, with the highest velocity shown by the top and bottom contours.

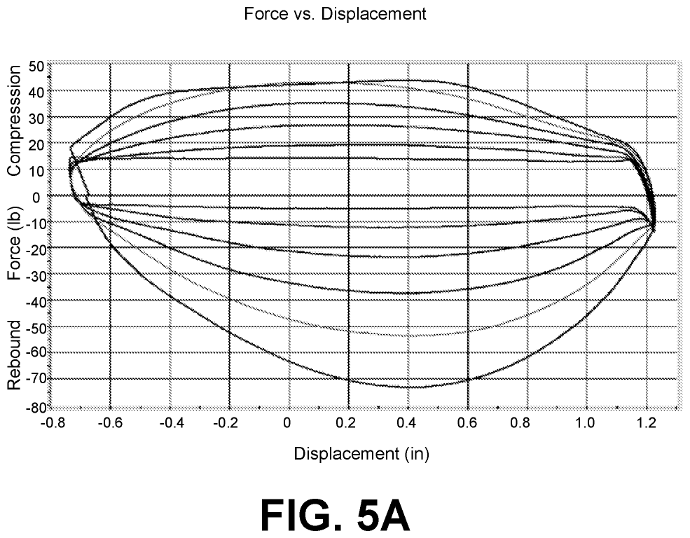

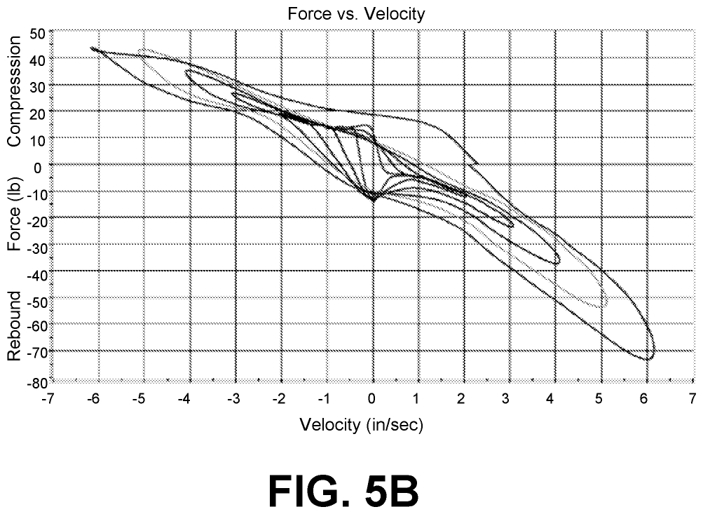

FIG. 5A shows the force vs. displacement plot of the double damper 100 when it is subjected to no control algorithm, and the upper end of the shock dyno 206 is not free to move. This condition resembles a passive damper. In this case, a continuous signal of +5V is supplied to the solenoid valve which ensures that the valve is fully open during the entire test and the damping characteristics of the damper is at its minimum value. Each closed contour indicates the force-displacement plot at a specific velocity of the damper. The area under each contour shows the amount of energy absorbed by the damper for that cycle. The results agree with the literature that; as the velocity increases, the area under the contour plot increases.

FIG. 5B shows the force vs. velocity plot of the double damper 100 when the solenoid valve is fully open. Similar to FIG. 5A, each contour indicates the force at a specific velocity of the damper. The hysteresis loop is observed during each cycle, indicating the presence of friction between the piston and the inner walls of the damper during the compression and the rebound stroke.

In order to observe the frequency domain characteristics and compare the dampers better, the following method is used. In these experiments, the accelerometer data of the sprung mass and unsprung mass accelerations are recorded. The dampers are excited with a constant velocity in order to compare the response of the dampers to control logic.

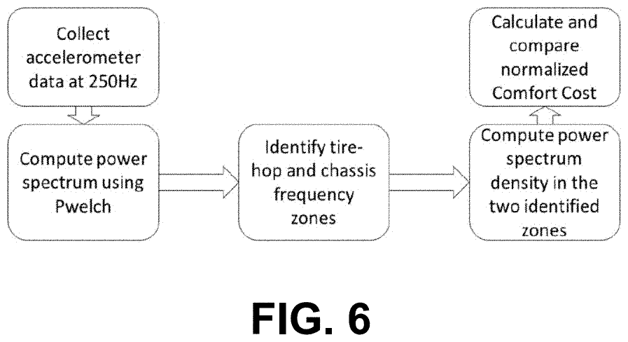

FIG. 6 is a diagram illustrating a data processing workflow for comparison of semi-active single damper and double damper performance. The single damper is initially tested for an unsprung input velocity of 0.2 m/s, with a sampling frequency of 240 Hz. Fast Fourier transform of the signal is calculated by using Welch's method to see the frequency domain characteristics and differentiate between the control algorithms better. Since the conversion of a signal from time domain to frequency domain is sensitive to effects of noise, it is preferable to have a method that would not be affected by the presence of stochastic noise in the signal. Instead of extracting the Fourier coefficients of the time domain signal, Welch's method involving averaging and Hamming windowing is used in equation (2):

$$w ( n ) = 0.54 - 0.46 cos ( 2 π \frac{n}{N} ) \qquad ( 2 )$$

Where 0≤n≤N, window length is L=N+1, Nis the total number of points, and w are the coefficients of the Hamming window.

The given signal is split into several sections using windowing techniques, and overlap. There is an overlap present between two consecutive sections in the signal. The power spectrum of each section, or window is computed, and overlapped hence eliminating effect of stochastic noise. With this, the frequency domain plots for single semi-active damper with Skyhook control, single semi-active damper with Groundhook control, and double-semi active damper with Skyhook-Groundhook control are obtained.

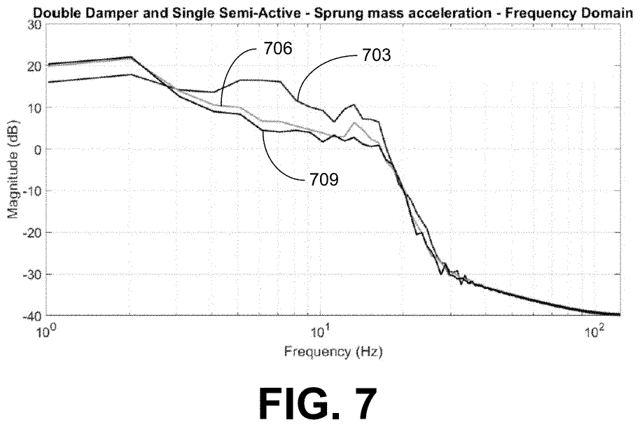

FIG. 7 shows one example of a frequency domain sprung mass acceleration plot for both a semi-active single damper and the double damper 100 (FIG. 1). The double damper 100 results are shown at 703. The results for the single damper with Skyhook control are shown at 706. The results for the single damper with Groundhook control are shown at 709. Two distinct zones of frequencies can be observed from FIG. 7, around 1 Hz and 10 Hz. These are the chassis/sprung mass frequency and tire-hop frequencies, respectively. The areas under the Power Spectral Density (PSD) plot of the signal in the frequency domain in both low-frequency (chassis responses) and high frequencies (tire-hop) are a measure of the damping characteristic of a damper, as in equation (3):

G(X,f₁,f₂)=∫_{f}_{₁}^{f}^{₂}|X(f)|²df (3)

Where G(X, f₁, f₂) represents a function that calculates the squared area under signal X(f), in the range of frequencies of interest f₁ and f₂. However, since the system is a discrete time system, numerical integration by trapezoidal method is used, as in equation (4):

$$G ( X , {f}_{1} , {f}_{2} ) = \frac{{f}_{2} - {f}_{1}}{2 N} {\sum }_{n = 1}^{N} {( X ( {f}_{n} ) + X ( {f}_{n + 1} ) )}^{2} \qquad ( 4 )$$

Where N are the number of points in the signal. The normalized cost function in equation (5) represents the “comfort cost,” which is used as a metric for evaluating the control algorithm:

$${J}_{comfort} = \frac{G ( {F}_{z} , 0 , 20 )}{G ( {F}^{n o m z} , 0 , 20 )} \qquad ( 5 )$$

Where G(F^{nomz}, 0, 20) is the nominal (passive) reference suspension variance gains from 0 to 20 Hz, and G(F_{z}, 0, 20) is the variance gain of the system considered.

As seen in FIG. 7, the area under the power spectrum density plot in the chassis frequency zone is less for the double damper 100 with control, which signifies that the resonant peaks in that zone are damped, and the ride will be softer. In a nutshell, smaller the “comfort cost,” the smoother is ride quality. Following this, the “comfort cost” is evaluated. This “comfort cost” is the power spectrum density around the chassis frequency zone and the tire-hop frequency zone.

It can be concluded from these “comfort costs,” that the double damper 100 with the Groundhook-Skyhook controller has a smaller cost value. This means that the double damper provides a much smoother and softer ride as compared to the traditional Skyhook control and Groundhook control of the single-semi active damper. In addition to this, it is seen that in the tire-hop frequency zone, the double damper with control performs slightly worse than the single damper with control. This shows that the double damper with control is better suited for a softer ride, rather than for road holding.

The features, structures, or characteristics described above may be combined in one or more embodiments in any suitable manner, and the features discussed in the various embodiments are interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

The embodiments of the control system 301 described herein can be implemented in hardware, software, or a combination of hardware and software. If embodied in software, the functions, steps, and elements can be implemented as a module or set of code that includes program instructions to implement the specified logical functions. The program instructions can be embodied in the form of, for example, source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

The embodiments of the control system 301 can be implemented by at least one processing circuit or device and at least one memory circuit or device. Such a processing circuit can include, for example, one or more processors and one or more storage or memory devices coupled to a local interface. The local interface can include, for example, a data bus with an accompanying address/control bus or any other suitable bus structure. The memory circuit can store data or components that are executable by the processing circuit.

If embodied as hardware, the functions, steps, and elements can be implemented as a circuit or state machine that employs any suitable hardware technology. The hardware technology can include, for example, one or more microprocessors, discrete logic circuits having logic gates for implementing various logic functions upon an application of one or more data signals, application specific integrated circuits (ASICs) having appropriate logic gates, and/or programmable logic devices (e.g., field-programmable gate array (FPGAs), and complex programmable logic devices (CPLDs)).

Also, one or more of the components described herein that include software or program instructions can be embodied in any non-transitory computer-readable medium for use by or in connection with an instruction execution system such as, a processor in a computer system or other system. The computer-readable medium can contain, store, and/or maintain the software or program instructions for use by or in connection with the instruction execution system.

A computer-readable medium can include a physical media, such as, magnetic, optical, semiconductor, and/or other suitable media. Examples of a suitable computer-readable media include, but are not limited to, solid-state drives, magnetic drives, or flash memory. Further, any logic or component described herein can be implemented and structured in a variety of ways. For example, one or more components described can be implemented as modules or components of a single application. Further, one or more components described herein can be executed in one computing device or by using multiple computing devices.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims. If a component is described as having “one or more” of the component, it is understood that the component can be referred to as “at least one” component.

The terms “first,” “second,” etc. are used only as labels, rather than a limitation for a number of the objects. It is understood that if multiple components are shown, the components may be referred to as a “first” component, a “second” component, and so forth, to the extent applicable.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A double damper, comprising:
a first semi-active damper including a first piston rod, a first gas chamber, a first compression chamber, a first rebound chamber, and a first bypass chamber, the first bypass chamber including a first controllable bypass valve; and
a second semi-active damper including a second piston rod, a second gas chamber, a second compression chamber, a second rebound chamber, and a second bypass chamber including a second controllable bypass valve,
wherein the first semi-active damper and the second semi-active damper are connected via an adjustable sleeve.

2. The double damper of claim 1, further comprising a first eyelet attached to an outside end of the first piston rod, the first eyelet configured to connect to a vehicle chassis, and a second eyelet attached to an outside end of the second piston rod, the second eyelet configured to attach to an unsprung mass.

3. The double damper of claim 1, wherein the first controllable bypass valve and the second controllable bypass valve comprise proportional, solenoid-operated, two-way, spool-type, normally closed fluid metering valves.

4. The double damper of claim 1, wherein the first gas chamber and the second gas chamber are nitrogen-filled.

5. The double damper of claim 1, wherein the first compression chamber and the second compression chamber are filled with hydraulic oil.

6. The double damper of claim 1, wherein operation of the first controllable bypass valve controls a flow rate of hydraulic oil passing from the first compression chamber to the first rebound chamber, and operation of the second controllable bypass valve controls a flow rate of hydraulic oil passing from the second compression chamber to the second rebound chamber.

7. A system, comprising:
a double damper comprising a first semi-active damper and a second semi-active damper in series via a sleeve arrangement;
the first semi-active damper having a first controllable bypass valve that controls a flow of hydraulic oil from a first compression chamber to a first rebound chamber;
the second semi-active damper having a second controllable bypass valve that controls a flow of hydraulic oil from a second compression chamber to a second rebound chamber; and
a controller that operates the first controllable bypass valve according to a Skyhook control algorithm and operates the second controllable bypass valve according to a Groundhook control algorithm.

8. The system of claim 7, further comprising:
a first accelerometer mounted at an end of the first semi-active damper corresponding to a sprung mass;
a second accelerometer mounted on a body of the double damper; and
a third accelerometer mounted at an end of the second semi-active damper corresponding to an unsprung mass.

9. The system of claim 8, wherein velocity readings from the first accelerometer and the second accelerometer are used in the Skyhook control algorithm.

10. The system of claim 8, wherein velocity readings from the second accelerometer and the third accelerometer are used in the Groundhook control algorithm.

11. The system of claim 7, wherein a first piston rod of the first damper is attached to a body of an automotive vehicle via a first eyelet, and a second piston rod of the second damper is attached to a wheel hub assembly of the automotive vehicle via a second eyelet.

12. The system of claim 7, wherein the first semi-active damper is positioned vertically above the second semi-active damper.

13. The system of claim 7, wherein the first controllable bypass valve is connected to the first compression chamber and the first rebound chamber by a plurality of first hydraulic hoses that exit a body of the double damper, and the second controllable bypass valve is connected to the second compression chamber and the second rebound chamber by a plurality of second hydraulic hoses that exit the body.

14. The system of claim 7, wherein the first semi-active damper further comprises a first gas chamber separated from the first compression chamber by a first floating piston, and the second semi-active damper further comprises a second gas chamber separated from the second compression chamber by a second floating piston.

15. A double damper, comprising:
a first damper including a first piston rod, a first gas chamber, a first compression chamber, and a first rebound chamber; and
a second damper including a second piston rod, a second gas chamber, a second compression chamber, and a second rebound chamber,
wherein the first damper and the second damper are connected via a sleeve from which the first piston rod and the second piston rod extend at opposite ends.

16. The double damper of claim 15, wherein the first damper and the second damper are separated by the sleeve.

17. The double damper of claim 15, wherein the first damper further comprises a first bypass chamber, the second damper further comprises a second bypass chamber, and the first bypass chamber and the second bypass chamber are external to a body of the double damper.

18. The double damper of claim 15, wherein at least one of the first damper or the second damper are passive dampers.

19. The double damper of claim 15, wherein at least one of the first damper or the second damper are semi-active dampers.

20. The double damper of claim 15, wherein at least one of the first damper or the second damper are active dampers.
